(19) United States
(12) Patent Application Publication
(10) Pub. No.: US 2024/0395010 A1
(43) Pub. Date: Nov. 28, 2024

(54) RECOGNITION APPARATUS, RECOGNITION METHOD, AND NON-TRANSITORY COMPUTER-READABLE MEDIUM

(71) Applicant: CANON KABUSHIKI KAISHA, Tokyo (JP)

(72) Inventors: HIDEO KUBOYAMA, Kanagawa (JP); TOMOAKI NEGISHI, Kanagawa (JP)

(21) Appl. No.: 18/797,422

(22) Filed: Aug. 7, 2024

Related U.S. Application Data
(63) Continuation of application No. PCT/JP2023/006989, filed on Feb. 27, 2023.

(30) Foreign Application Priority Data
Mar. 14, 2022 (JP) 2022-039556
Mar. 14, 2022 (JP) 2022-039558

(51) Int. Cl. G06V 10/70; G06T 7/00

(52) U.S. Cl. CPC G06V 10/70; G06T 7/0002

(57) ABSTRACT

A recognition apparatus is provided. The apparatus obtains recognition target information that is a target of recognition processing. The apparatus obtains information indicating details of past recognition processing output in the past recognition processing performed with use of a model. The apparatus performs recognition processing on the recognition target information with use of a model in accordance with the information indicating details of the past recognition processing.

### CROSS-REFERENCE TO RELATED APPLICATIONS

This application is a Continuation of International Patent Application No. PCT/JP2023/006989, filed Feb. 27, 2023, which claims the benefit of Japanese Patent Application No. 2022-039556, filed Mar. 14, 2022, and Japanese Patent Application No. 2022-039558, filed Mar. 14, 2022, all of which are hereby incorporated by reference herein in their entirety.

### BACKGROUND OF THE INVENTION

### Field of the Invention

The present invention relates to a recognition apparatus, a recognition method, and a non-transitory computer-readable medium, or more specifically, relates to defect detection processing performed on an image of a structure, for example.

### Background Art

There are recognition apparatuses and recognition services for recognizing a recognition target such as a predetermined object from information such as an image. In such a recognition apparatus, training of a model such as a CNN (Convolutional Neural Network) is performed with use of a large amount of training data, and a recognition target can be recognized from information that is input, with use of the trained model.

For example, Japanese Patent No. 6807093 discloses a technology for detecting cracks from an image captured by an unmanned flying object with use of a trained model. In Japanese Patent No. 6807093, cracks are detected with use of two types of models, i.e., a specialized learning model that can identify a particular type of cracks and a non-specialized learning model that can identify a plurality of types of cracks other than the particular type of cracks.

### SUMMARY OF THE INVENTION

According to an embodiment, a recognition apparatus comprises one or more memories storing instructions and one or more processors that execute the instructions to: obtain recognition target information that is a target of recognition processing; obtain information indicating details of past recognition processing output in the past recognition processing performed with use of a model; and perform recognition processing on the recognition target information with use of a model in accordance with the information indicating details of the past recognition processing.

According to another embodiment, a recognition apparatus comprises one or more memories storing instructions and one or more processors that execute the instructions to: perform recognition processing on recognition target information that is a target of recognition processing with use of a model; and output information indicating details of the recognition processing in association with a result of the recognition processing.

According to still another embodiment, a recognition method comprises: obtaining recognition target information that is a target of recognition processing; obtaining information indicating details of past recognition processing output in the past recognition processing performed with use of a model; and performing recognition processing on the recognition target information with use of a model in accordance with the information indicating details of the past recognition processing.

According to yet another embodiment, a recognition apparatus comprises a model manager configured to manage models to be used in recognition processing, one or more memories storing instructions, and one or more processors that execute the instructions to: obtain a result of first recognition processing performed on first recognition target information with use of a first model; perform recognition processing on the first recognition target information in accordance with each of a plurality of settings with use of a model which is different from the first model and is managed by the model manager, and generate results of the recognition processing respectively corresponding to the plurality of settings; and output a setting corresponding to a result of the recognition processing selected with reference to the result of the first recognition processing from the results of the recognition processing respectively corresponding to the plurality of settings.

According to still yet another embodiment, a recognition method compress: obtaining a result of first recognition processing performed on first recognition target information with use of a first model; performing recognition processing on the first recognition target information in accordance with each of a plurality of settings with use of a model which is different from the first model and is managed by a model manager configured to manage models to be used in recognition processing, and generating results of the recognition processing respectively corresponding to the plurality of settings; and outputting a setting corresponding to a result of the recognition processing selected with reference to the result of the first recognition processing from the results of the recognition processing respectively corresponding to the plurality of settings.

According to yet still another embodiment, a non-transitory computer-readable medium stores a program executable by a computer to perform a method comprising: obtaining recognition target information that is a target of recognition processing; obtaining information indicating details of past recognition processing output in the past recognition processing performed with use of a model; and performing recognition processing on the recognition target information with use of a model in accordance with the information indicating details of the past recognition processing.

According to still yet another embodiment, a non-transitory computer-readable medium storing a program executable by a computer to perform a method comprising: obtaining a result of first recognition processing performed on first recognition target information with use of a first model; performing recognition processing on the first recognition target information in accordance with each of a plurality of settings with use of a model which is different from the first model and is managed by a model manager configured to manage models to be used in recognition processing, and generating results of the recognition processing respectively corresponding to the plurality of settings; and outputting a setting corresponding to a result of the recognition processing selected with reference to the result of the first recognition processing from the results of the recognition processing respectively corresponding to the plurality of settings.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing a functional configuration example of a recognition apparatus according to an embodiment.

FIG. 2 is a diagram showing a hardware configuration example of the recognition apparatus according to an embodiment.

FIG. 3 is a diagram showing an example of a processing flow of a recognition processing method according to an embodiment.

FIG. 4 is a diagram showing an example of a UI that is used by a user to set model information.

FIG. 5 is a diagram showing output and input of model information.

FIG. 6 is a diagram showing an example of a UI that is displayed when a non-displayed model is called.

FIG. 7 is a diagram showing an example of a model management table.

FIG. 8 is a diagram showing operations of a switching unit 111.

FIG. 9 is a diagram showing an example of a processing flow for presenting a display target model.

FIG. 10 is a diagram showing an example of a lookup table showing a relationship between models.

FIG. 11 is a diagram showing an example of a UI for presenting results of recognition processing obtained with use of respective models.

FIG. 12 is a block diagram showing a functional configuration example of a recognition apparatus according to an embodiment.

FIG. 13 is a flowchart of a recognition processing method according to an embodiment.

FIG. 14 is a diagram showing an example of a display screen showing logs of recognition processing.

FIG. 15 is a diagram showing an example of a user interface for performing setting of recognition processing.

FIG. 16 is a diagram showing an example of a screen proposing search processing.

FIG. 17 is a diagram showing an example of a screen displaying a search result.

FIG. 18 is a diagram showing an example of log information managed by a log management unit 1122.

FIG. 19 is a flowchart of search processing.

FIG. 20 is a diagram showing an example of model classification information managed by a model management unit 1106.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

A user of a recognition apparatus may want to compare a result of recognition processing performed on past information (e.g., a past image of a structure) with a result of recognition processing performed on current information (e.g., a current image of the structure). In such a case, in order to compare the results, it is preferable to maintain a recognition environment that enables reproduction of a recognition result similar to the result of the recognition processing performed in the past and apply the environment to the recognition processing performed on different information. However, it is troublesome to manually set parameters of the recognition processing in order to obtain a recognition result similar to the result of the recognition processing performed in the past. In particular, a learning model used for recognition processing may be updated in the recognition apparatus. In such a case, in order to use the same learning model as that used in the past, a plurality of versions of the learning model need to be maintained, and the user is required to perform a troublesome operation of identifying and selecting the learning model used in the recognition processing in the past from among the plurality of versions.

Also, in an inspection of a structure, transition of defects may be analyzed by comparing images. Specifically, the degree of progress of defects can be evaluated by analyzing extension or widening of cracks in the structure. In such a case, the recognition result changes if a model or a processing parameter used in the recognition processing changes, and accordingly, it is desirable to perform the recognition processing in a recognition environment in which a similar recognition result can be obtained.

On the other hand, a provider of the recognition apparatus may update a model and discontinue the old model. In this case, the previously used model cannot be used for recognition processing, and it may be difficult to compare results of recognition processing performed on pieces of information corresponding to different points in time.

An embodiment of the present invention makes it possible to easily reproduce a recognition environment used in recognition processing in the past.

Another embodiment of the present invention makes it possible to easily perform setting of recognition processing in such a manner that the recognition processing can be performed in a recognition environment in which a recognition result similar to that obtained in past recognition processing can be reproduced.

### Embodiment 1

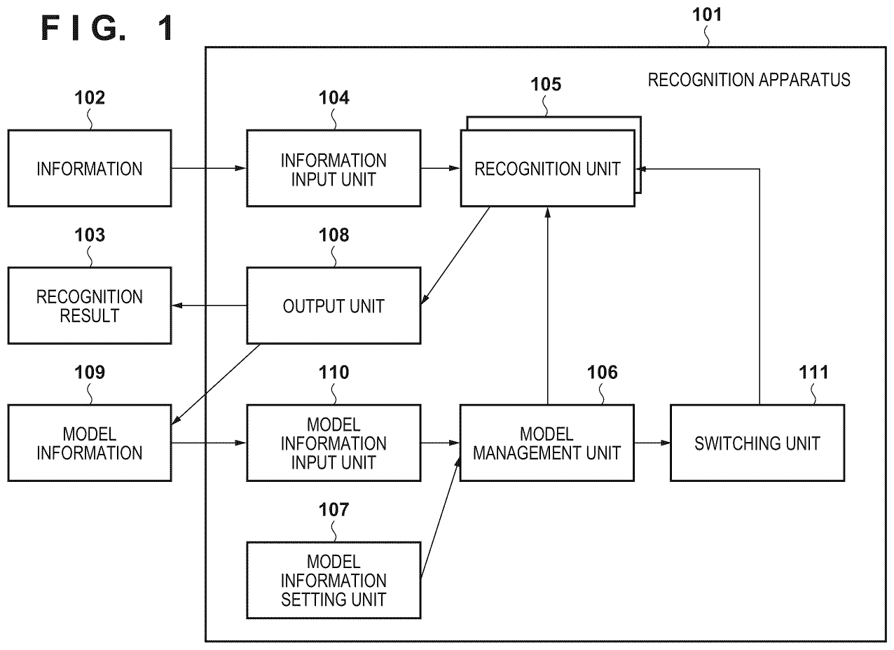

FIG. 1 shows a functional configuration of a recognition apparatus according to Embodiment 1, which is an embodiment of the present invention. Information (recognition target information) 102 that is a target of recognition processing is input to a recognition apparatus 101, and the recognition apparatus 101 outputs a recognition result 103 obtained by performing recognition processing on the recognition target information 102. There is no particular limitation on the type of the target of recognition processing, and the target may be an image, text information, audio information, or signal information, for example. There is no particular limitation on the type of the recognition processing, and the recognition processing may be processing for recognizing a recognition target from an image, processing for generating a summary from text information, or processing for recognizing an abnormality from a sound generated by a hammer impacting on a structure or a sensor signal obtained from a device, for example. In the following embodiment, a case is described in which the recognition apparatus 101 recognizes a defect such as a crack occurring in a structure included in an image from the image. The structure may be an infrastructure such as a tunnel or a bridge, for example.

The recognition apparatus 101 includes an information input unit (first obtaining unit) 104, a model information input unit (second obtaining unit) 110, and a recognition unit (recognizer) 105. The first obtaining unit 104 obtains the recognition target information 102 that is a target of recognition processing. The second obtaining unit 110 obtains information indicating details of past recognition processing output in the past recognition processing performed with use of a model. Information indicating details of recognition processing can include information for identifying a model, such as a model ID that is identification information of the model. Also, information indicating details of recognition processing can include processing parameters used in the recognition processing performed with use of a model. Furthermore, information indicating details of recognition processing can include information indicating a recognition target. Hereinafter, information indicating details of recognition processing will be referred to as “model information”. That is to say, the second obtaining unit 110 obtains model information 109.

Here, the information indicating details of the past recognition processing may be associated with a result of the past recognition processing. For example, information indicating the result of the past recognition processing may include the information indicating details of the past recognition processing. In this case, when a user inputs the result of the past recognition processing to the second obtaining unit 110, the second obtaining unit 110 can obtain the information indicating details of the past recognition processing. Note that the recognition apparatus 101 may also be realized as a server or a cloud service, and in this case, the first obtaining unit 104 and the second obtaining unit 110 can obtain the recognition target information 102 and the model information 109 via a network.

The recognition unit 105 performs recognition processing on the recognition target information by using a model. Here, the recognition unit 105 can perform the recognition processing in accordance with the information indicating details of the past recognition processing, which is obtained by the second obtaining unit 110, as described later. For example, the recognition unit 105 can use a model used in the past recognition processing and processing parameters used in the past recognition processing in the recognition processing performed on the recognition target information. The recognition apparatus 101 may include a plurality of recognition units 105 as described later, and in this case, each of the recognition units 105 corresponds to at least one model among a plurality of models.

The recognition apparatus 101 may further include a model management unit (model manager) 106, a setting unit 107, an output unit 108, and a switching unit 111. The model management unit 106 manages one or more models that are used by the recognition unit 105 to perform recognition processing on the recognition target information. Also, the model management unit 106 may select a model to be used in the recognition processing from the managed models in accordance with model information. For example, the model management unit 106 can select a model identified based on the model information from the managed models.

The setting unit 107 can perform setting of model information in accordance with input made by the user. The output unit 108 can output a result of the recognition processing performed on the recognition target information 102 by the recognition unit 105. Also, the output unit 108 can output information (model information) indicating details of the recognition processing performed by the recognition unit 105 in association with the result of the recognition processing. The switching unit 111 switches the recognition unit 105 that performs recognition processing, in accordance with model information.

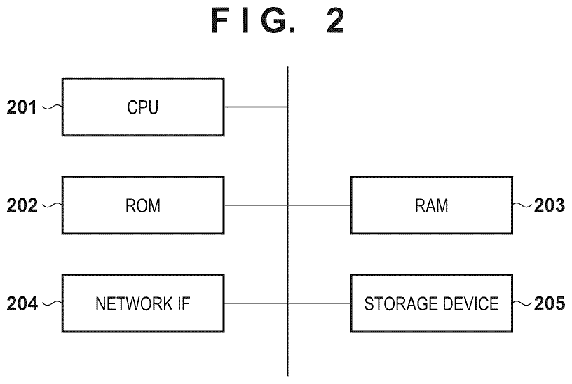

The recognition apparatus 101 according to the present embodiment can be realized by a computer that includes a processor and a memory. FIG. 2 shows a hardware configuration example of the recognition apparatus 101 according to an embodiment. A CPU (Central Processing Unit) 201 executes a control program of the recognition apparatus 101. A ROM 202 stores the control program and the like therein. A RAM 203 provides a work area for the CPU 201. A network IF 204 is used to communicate with an application outside the recognition apparatus 101. A storage device 205 is a hard disk, for example, and stores data or a program therein. As described above, functions of the units shown in FIG. 1 and the like can be realized due to a processor such as the CPU 201 executing a program stored in a memory such as the ROM 202, the RAM 203, or the storage device 205.

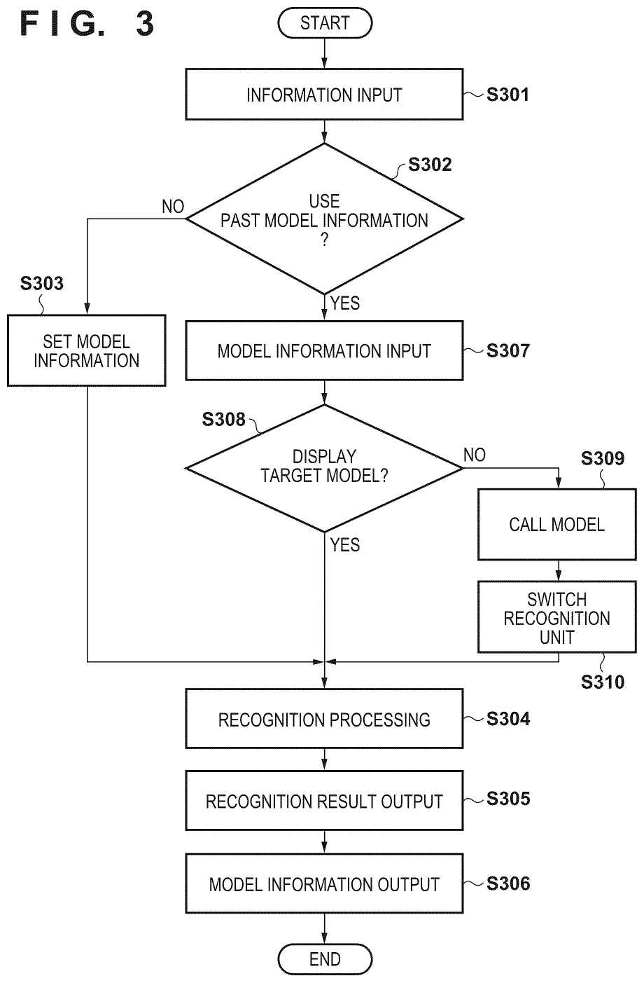

FIG. 3 shows a processing flow of a recognition processing method performed by the recognition apparatus according to an embodiment of the present invention. In step S301, the first obtaining unit 104 obtains an image that is recognition target information. In step S302, the setting unit 107 determines whether or not to use model information 109 indicating details of past recognition processing. When the past model information is not used, the processing proceeds to step S303, and when the past model information is used, the processing proceeds to step S307.

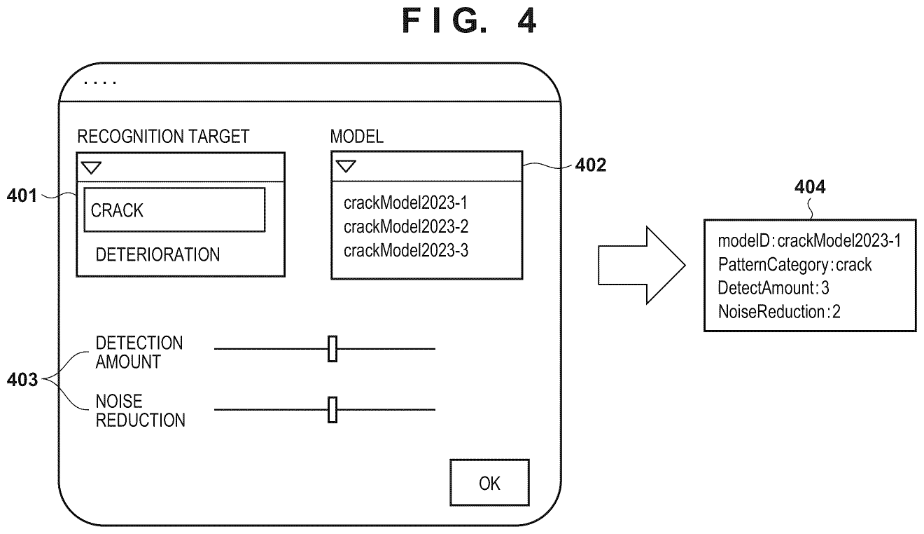

In step S303, the setting unit 107 sets model information. In this example, the setting unit 107 sets model information based on input made by the user. FIG. 4 shows a user interface UI that is used by the user of the recognition apparatus 101 to set model information. The UI shown in FIG. 4 includes a list 401 for selecting a recognition target and a list 402 for selecting a model to be used in the recognition processing. The user can select a model to be used in the recognition processing from among one or more models corresponding to the recognition target by using the list 402. Furthermore, the UI shown in FIG. 4 includes sliders 403 for specifying processing parameters to be used in the recognition processing. The processing parameters can include a detection amount parameter for controlling the amount of the recognition target to be detected in the recognition processing (making the recognition target more likely to be detected or less likely to be detected), for example. Also, the processing parameters can include a noise reduction parameter indicating the intensity of noise reduction processing that is preprocessing performed on the recognition target information. Of course, the processing parameters are not limited to these types of parameters.

Based on input made by the user on such a UI described above, the setting unit 107 can generate model information 404 indicating details of the recognition processing. The model information 404 shown in FIG. 4 indicates a model ID that is identification information of a model, a recognition target, and processing parameters. As described above, in step S303, the user can select a model or adjust the processing parameters to obtain a better result of the recognition processing. On the other hand, there is no limitation to this method for setting model information by the setting unit 107. For example, the setting unit 107 may automatically set the model information based on an attribute of the recognition target information (e.g., a time zone in which the information was obtained, the brightness of the image, or GPS information) and the type of the recognition target.

In step S304, the recognition unit 105 performs recognition processing on the recognition target information by using the model. The recognition unit 105 can perform the recognition processing in accordance with the model information set by the setting unit 107 in step S303. Also, the recognition unit 105 can perform the recognition processing in accordance with model information indicating details of past recognition processing, which is obtained by the second obtaining unit 110 in step S307. In the present embodiment, the recognition unit 105 performs processing for recognizing defects on an image.

In step S305, the output unit 108 outputs the result of the recognition processing performed in step S304. In the present embodiment, the output unit 108 can superimpose the position of a recognized defect such as a crack on the image that is the recognition target information and output the superimposed image. Also, the output unit 108 may output vector data of the crack. However, there is no particular limitation on the recognition processing performed by the recognition apparatus according to the present invention as described above, and the output unit 108 may output the result in various forms.

In step S306, the output unit 108 outputs model information indicating details of the recognition processing performed in step S304. For example, the output unit 108 can output the model information 404 shown in FIG. 4 as text in a predetermined format or binary data. The output unit 108 can output the model information in association with the result of the recognition processing. For example, information indicating the result of the recognition processing may include the model information. This configuration enables the user of the recognition apparatus 101 to manage the model information used in the recognition processing together with the result of the recognition processing and know model information used to obtain a particular result of recognition processing. Note that the output unit 108 can output the result of the recognition processing and the model information to an external device via a network or the like in steps S305 and S306. On the other hand, the output unit 108 may also store the result of the recognition processing and/or the model information in a storage device included in the recognition apparatus 101 in steps S305 and S306, and in this case, the output unit 108 can output the result of the recognition processing and/or the model information to the outside at any timing in accordance with a request from the user.

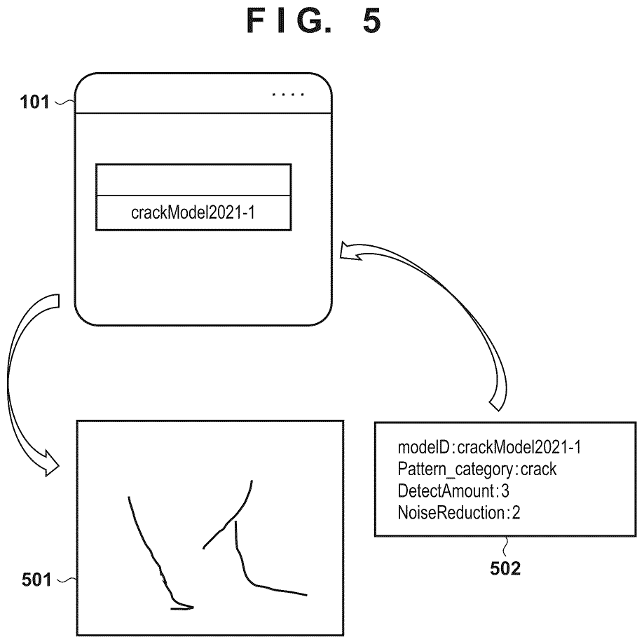

In step S307, the second obtaining unit 110 obtains model information indicating details of the past recognition processing. The model information is model information output by the output unit 108 in step S306 in the past recognition processing. That is to say, as shown in FIG. 5, the user of the recognition apparatus 101 inputs an image to the recognition apparatus 101 at a point in time, and the recognition apparatus 101 outputs a recognition result 501 and model information 502 regarding this image. The recognition result 501 is obtained by superimposing a result of the recognition processing on the input image. The recognition apparatus 101 can restore a setting used in the past recognition processing due to the second obtaining unit 110 obtaining the model information 502. Thereafter, in step S304, the recognition unit 105 can perform recognition processing on the recognition target information in accordance with the model information obtained in step S307.

On the other hand, in an embodiment, the model management unit 106 can manage a first model group and a second model group by distinguishing these groups. For example, the model management unit 106 can select a model to be used in the recognition processing from the first model group based on model information set by the setting unit 107 (e.g., in accordance with input made by the user), irrespective of the model information obtained by the second obtaining unit 110. On the other hand, the model management unit 106 can select a model to be used in the recognition processing from the second model group in accordance with the model information obtained by the second obtaining unit 110. In an embodiment, the model management unit 106 can perform both processing for determining a model to be used in the recognition processing from the first model group in accordance with input made by the user and processing for selecting a model identified based on model information from the second model group. Here, models managed by the model management unit 106 can include display target models that are presented to the user in step S303 and can be selected by the user from a list and non-displayed models that are not presented to the user in step S303 and cannot be selected by the user from the list. In this case, the models in the first model group are the display target models, the second model group includes the display target models and the non-displayed models, and the number of models included in the first model group is smaller than the number of models included in the second model group.

A provider of the recognition apparatus 101 may update a model to improve recognition performance, for example. In this case, the model management unit 106 can manage the model prior to the update as a non-displayed model and manage an updated model as a display target model. As described above, a model that was a display target model can be managed as a non-displayed model when the model is updated. Non-displayed models are hidden from the user when model information is set in step S303 such as a case where the recognition apparatus 101 is used for a new application or a new user uses the recognition apparatus 101. According to this configuration, new display target models are usually used, and accordingly, old models can be kept from being used. Also, only new models are presented to the user, and the number of presented models is reduced, and accordingly, usability improves. On the other hand, when model information is obtained in step S307 to reproduce a recognition environment used in the past, the recognition apparatus 101 can use a non-displayed model indicated by the model information.

Therefore, in step S308, the model management unit 106 determines whether or not a model indicated by the model information obtained in step S307 is a display target model. The model management unit 106 can determine whether the model is a display target model or a non-displayed model based on a model ID included in the model information. If the model is a display target model, the processing proceeds to step S304, and the recognition unit 105 performs recognition processing on the recognition target information in accordance with the model and processing parameters indicated by the model information obtained in step S307. On the other hand, if the model is not a display target model, the processing proceeds to step S309.

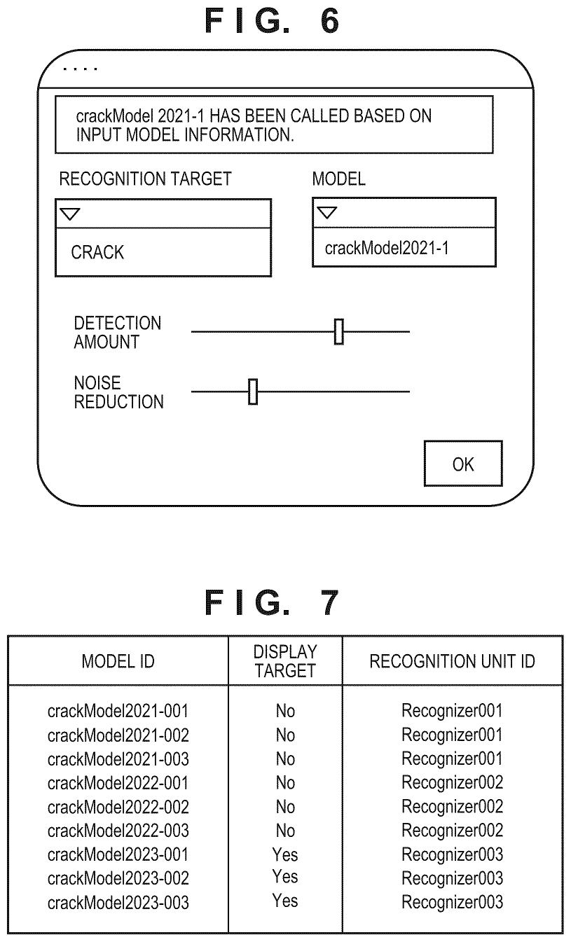

In step S309, the model management unit 106 calls a non-displayed model indicated by the model information obtained in step S307. FIG. 6 shows a UI displayed when the model information is obtained by the second obtaining unit 110 in step S307 and the non-displayed model is called by the model management unit 106 in step S309. The model indicated by the model information obtained in step S307 is “crackModel2021-1”. On the other hand, as a result of the model having been updated, display target models that can be selected for the recognition target “cracks” at this point in time are “crackModel2023-1”, “crackModel2023-2”, and “crackModel2023-3”. However, “crackModel2021-1” has not been deleted from the model management unit 106, and accordingly, the model used in the past is called in FIG. 6 by inputting past model information. On the other hand, as shown in FIG. 4, the three models: “crackModel2023-1”, “crackModel2023-2”, and “crackModel2023-3” are displayed in step S303 as the display target models that can be selected for the recognition target “cracks”. As described above, the non-displayed model “crackModel2021-1” is not displayed as an option in step S303. Note that the recognition target, the model, and/or the processing parameters may also be changed in step S309 based on input made by the user.

In step S310, the switching unit 111 switches the recognition unit 105 in accordance with the model to be used. Different recognition algorithms, libraries, and OSS may be used depending on the model used in the recognition processing. Therefore, the recognition apparatus 101 can use a plurality of recognition units 105. Here, each of the plurality of recognition units 105 corresponds to at least one model among the models managed by the model management unit 106. That is to say, each model can be associated with a single recognition unit 105. The switching unit 111 can switch the recognition units 105 to use a recognition unit 105 corresponding to the model ID indicated by the model information in the recognition processing.

When a non-displayed model is called in accordance with the model ID indicated by the model information and a recognition unit 105 corresponding to the model is determined as described above, the processing proceeds to step S304 and the recognition unit 105 performs recognition processing in accordance with the model and processing parameters indicated by the model information. The processing performed in step S304 and the following steps is as described above. Through the above-described processing, it is possible to output model information indicating details of recognition processing and reproduce a setting of the past recognition processing, i.e., a recognition environment in accordance with the output model information. Note that the configuration in which the switching unit 111 switches the recognition units 105 is not essential, and a configuration is also possible in which the same recognition unit 105 performs recognition processing by using various models.

### Details of Model Management

The following describes the processing performed in steps S307 to S310 in more detail. FIG. 7 shows a model management table used by the model management unit 106 to manage models. In the table shown in FIG. 7, each model ID is associated with a flag indicating whether or not the corresponding model is a display target model and an ID (recognition unit ID) of a recognition unit 105 that performs recognition processing by using the corresponding model. The model management unit 106 also manages the substance of a model corresponding to each model ID. In the present specification, “the substance of a model” means a structure and/or parameters expressing the model. For example, when a convolutional neural network is used as the model, the substance of the model can be expressed with structure information indicating the size of each layer and the number of layers, etc., and/or parameters such as filter coefficients used in convolutional processing performed between the layers. When the recognition unit 105 performs recognition processing in step S304, the model management unit 106 can supply information indicating the substance of the model corresponding to the model ID to the recognition unit 105 and the recognition unit 105 can establish the model by using the supplied information.

When a model that is to be used by the recognition apparatus 101 is added or updated, the model ID of the new model and a recognition unit ID can be added to the model management table. At this time, the model management unit 106 can set the flag indicating that the corresponding model is a display target model to Yes as for the latest model only, and set the flag to No as for old models. In this case, the old models cannot be selected when model information is usually set in step S303.

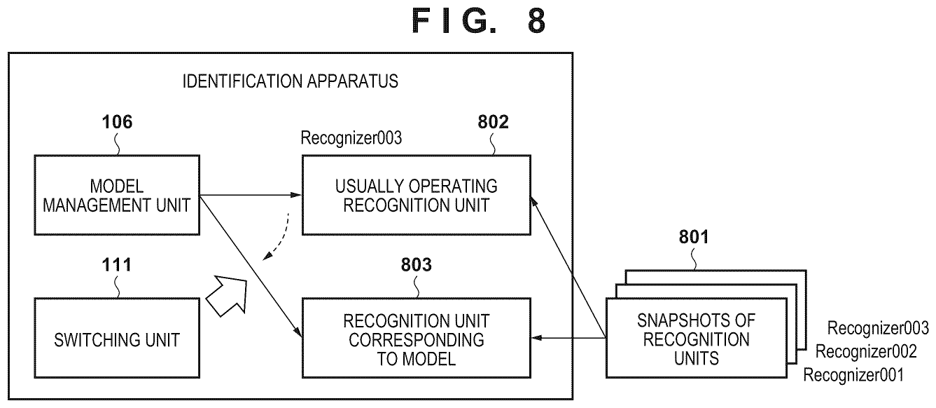

When the model management table described above is used, the model management unit 106 can determine whether or not the model indicated by the model ID is a display target model in step S308 by using the model ID indicated by the model information and the table. In step S309, the model management unit calls the model corresponding to the model ID by referring to the table. Furthermore, in step S310, the switching unit 111 switches the recognition unit 105 by referring to the table to use a recognition unit 105 that has a recognition unit ID corresponding to the model ID. FIG. 8 shows switching of the recognition unit 105 performed by the switching unit 111 in accordance with the model. The recognition units 105 may be libraries in the recognition apparatus 101 or servers or containers that accept recognition processing. Alternatively, the recognition units 105 may be respectively realized by different cloud services or the like.

In the example shown in FIG. 8, the plurality of recognition units 105 operate on corresponding containers, respectively. Each container executes the recognition processing as batch processing. A container 802 is a container for a recognition unit 105 that corresponds to a display target model, and usually operates. Also, the model management unit 106 manages snapshots (e.g., container images) of the containers respectively corresponding to the plurality of recognition units 105. The containers that are execution environments of applications such as the recognition units 105 and the snapshots keeping the states of the containers can be provided with use of a cloud service, for example.

In this case, the switching unit 111 can switch the recognition unit 105 that is called based on the model ID. Specifically, the switching unit 111 can boot the recognition unit 105 by using a snapshot of a container corresponding to the model selected by the model management unit 106 in accordance with the model information. In FIG. 8, the switching unit 111 boots the recognition unit 105 to be used in the recognition processing on a container 803 by using a snapshot of the recognition unit that has a recognition unit ID corresponding to the model ID.

In the example shown in FIG. 8, the model management unit 106 manages the latest models “crackModel2023-001”, “crackModel2023-002”, and “crackModel2023-003” as display target models. A recognition unit that has been booted on the container 802 with use of a snapshot including a recognition unit ID “Recognizer003” corresponding to these models usually operates. Recognition processing is performed with use of this recognition unit when model information is set in step S303 based on input made by the user and when it is determined in step S308 that the model information indicates a display target model.

On the other hand, when the model information indicates a model ID “crackModel2021-001” of a non-displayed model, the switching unit 111 determines that a recognition unit ID corresponding to the model ID is “Recognizer001” by referring to the model management table. Based on this, the switching unit 111 boots a recognition unit corresponding to the model on the container 803 by using a snapshot corresponding to the recognition unit ID “Recognizer001”. Then, the switching unit 111 switches the recognition unit to be used in the recognition processing from the recognition unit operating on the container 802 to the recognition unit operating on the container 803. Then, the recognition unit 105 booted on the container 803 performs the recognition processing on the recognition target information in step S304.

As described above, a recognition unit 105 that performs recognition processing with use of a display target model may usually operate in the recognition apparatus 101. When recognition processing is to be performed with use of a non-displayed model, the switching unit 111 can boot a recognition unit 105 that performs recognition processing with use of the non-displayed model and the recognition processing can be performed by this recognition unit 105. That is to say, the recognition apparatus may be configured in such a manner that a recognition unit 105 that uses a non-displayed model does not usually operate and is booted as necessary, while a recognition unit 105 that uses a display target model keeps operating.

In the embodiment described above, correspondence between models and the recognition units 105 is managed with use of the management table shown in FIG. 7. However, there is no limitation to this method for determining a recognition unit 105 corresponding to a model. For example, model information may indicate a recognition unit ID corresponding to the model to be used. Alternatively, a configuration is also possible in which, when model information is set in step S303, the setting unit 107 obtains input made by the user to select a recognition unit 105 from among one or more options and determines the recognition unit 105 to be used, based on the input made by the user.

As described above, the recognition apparatus according to the present embodiment can reproduce a setting of recognition processing used in the past based on model information output in the past recognition processing. Furthermore, in the embodiment described above, display target models and non-displayed models of previous versions, which cannot be usually selected, are managed by being distinguished from each other in accordance with addition or updating of models. Even if model information indicates a non-displayed model, when recognition processing is to be performed in accordance with the model information output in the past, it is possible to reproduce a past setting in which the non-displayed model is used. According to this method, it is possible to usually present only new display target models as options to cause the user to use the new display target models, but if the user wants to reproduce a past setting, it is possible to use an old non-displayed model.

In the embodiment described above, model information output by the output unit 108 indicates a model ID, a recognition target, and processing parameters used in the recognition processing, and the model management unit 106 manages models corresponding to model IDs. When the second obtaining unit 110 obtains model information, recognition processing is performed with use of a model corresponding to a model ID indicated by the model information. On the other hand, model information may also include information indicating the substance of a model as described above.

In this case, in response to the second obtaining unit 110 obtaining model information indicating the substance of a model, the recognition unit 105 can perform recognition processing on the recognition target information by using the model in accordance with the model information. For example, the output unit 108 can output a model information file that includes information indicating the substance of a model (e.g., structure information and/or parameters of the model) in a predetermined format. When the second obtaining unit 110 obtains this file, the model management unit 106 can restore the substance of the model based on the model information and transfer the substance of the model to the recognition unit 105. In this case, the second obtaining unit 110 can obtain model information indicating the substance of a model that is different from the models managed by the model management unit 106, and the recognition unit 105 can perform recognition processing with use of the model in accordance with the model information.

According to this configuration, model information output from the recognition apparatus 101 includes information indicating the substance of a model used in recognition processing, and if it is desired to reproduce a recognition environment, the model can be restored based on the model information. Accordingly, even if an old model is deleted when the model is updated by the recognition apparatus 101, it is possible to reproduce a past recognition environment. In this embodiment as well, the switching unit 111 can switch the recognition unit 105 that performs recognition processing with use of a model. In this case, information (e.g., a recognition unit ID) for identifying a recognition unit corresponding to the model can be held by the model management unit 106 or the model information.

### Presentation of Other Display Target Model Based on Model Information

In the embodiment described above, a past recognition environment is reproduced with use of a non-displayed model in accordance with model information output in the past. On the other hand, if it is sufficient that a recognition environment in which almost the same recognition result can be obtained is reproduced, the recognition apparatus 101 may also present a display target model corresponding to the non-displayed model indicated by the model information. According to this configuration, when the model information indicates a model prior to updating, it is possible to present an updated model to the user and encourage replacement of the older model by the updated model.

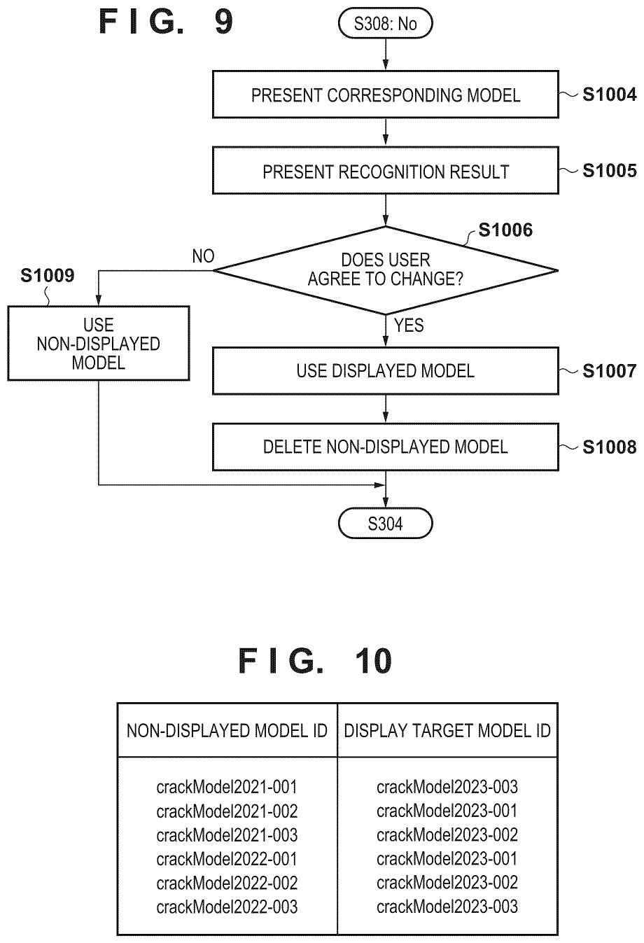

This embodiment can be realized by performing processing shown in FIG. 9 when it is determined in step S308 that the model information indicates a non-displayed model and the model identified based on the model information is not included in display target models. First, in step S1004, the model management unit 106 presents a model selected from the display target models to the user. Here, the model management unit 106 can present a display target model corresponding to the non-displayed model indicated by the model information. For example, the model management unit 106 may mange information indicating correspondence between non-displayed models and the displayed models. Based on such information, the model management unit 106 may determine the display target model that corresponds to the non-displayed model identified based on the model information and is presented to the user. Specifically, a configuration is possible in which an updated model that is similar to a model prior to updating is determined in advance, a lookup table indicating a relationship between these models is prepared, and the updated display target model corresponding to the non-displayed model prior to updating is selected based on the lookup table. FIG. 10 shows an example of such a lookup table, and in this case, a display target model ID is determined uniquely with respect to each non-displayed model ID.

As another example, a configuration is also possible in which a display target model corresponding to the non-displayed model indicated by the model information is determined based on a degree of similarity between recognition results. In this case, the recognition unit 105 can perform recognition processing on the recognition target information, a part of the recognition target information, or other information with use of the non-displayed model indicated by the model information and each of a plurality of display target models. Then, a display target model that outputs a recognition result that is the closest to a recognition result output by the non-displayed model is determined as the display target model corresponding to the non-displayed model.

In step S1005, the recognition unit 105 performs recognition processing by using the non-displayed model identified based on the model information and recognition processing by using the display target model presented to the user in step S1004. The recognition unit 105 can perform these types of recognition processing on the recognition target information, a part of the recognition target information, or other information. Also, the model management unit 106 can present the thus obtained results of the recognition processing to the user.

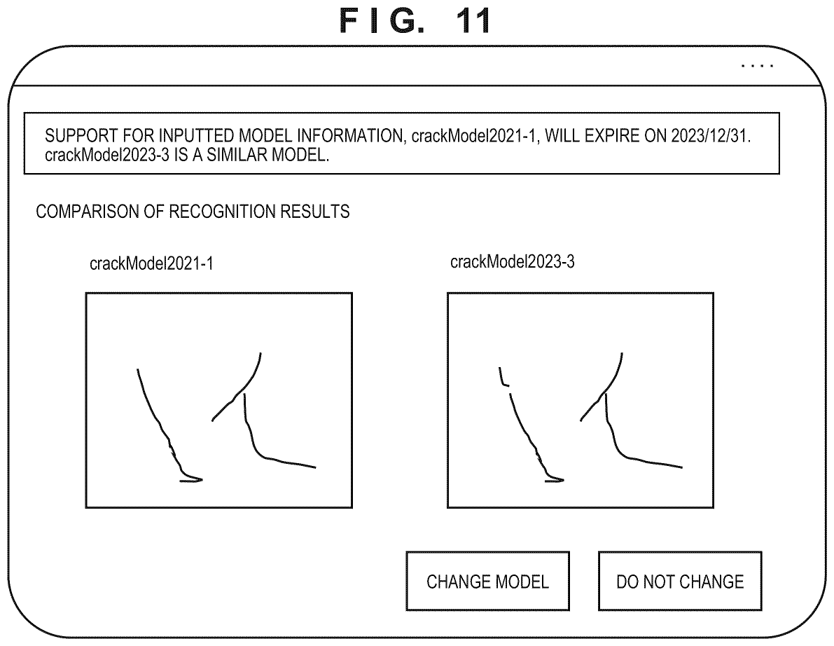

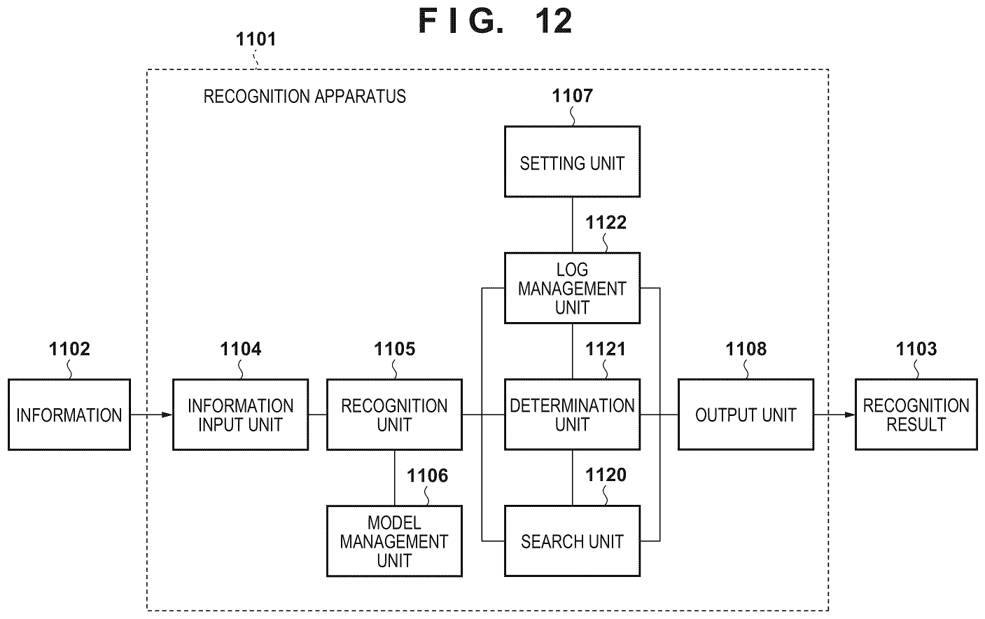

FIG. 11 shows an example of a UI presenting a model ID of the display target model corresponding to the non-displayed model indicated by the model information and a result of recognition processing performed with use of the display target model. Here, the display target model (ID: “crackModel2023-3”) corresponding to the non-displayed model (ID: “crackModel2021-1”) indicated by the model information and recognition results respectively obtained with use of these models are presented. Based on the recognition results, the user can determine whether or not the model can be changed.

In step S1006, the model management unit 106 obtains a user instruction indicating whether or not the user agrees to change the model. When the user agrees to change the model, the user can press the “change the model” button in the UI shown in FIG. 11, for example. When the user agrees to change the model, the processing proceeds to step S1007, and the model management unit 106 determines to use the display target model presented in step S1004 in the recognition processing.

Furthermore, the model management unit 106 may delete the non-displayed model indicated by the model information in step S1008. That is to say, in response to the instruction given in step S1007 from the user to whom the display target model was presented, the model management unit 106 may delete the model identified based on the model information. As a result of the model being deleted, the non-displayed model cannot be used even when model information obtained by the second obtaining unit 110 indicates the non-displayed model. Various methods are conceivable as a method for deleting the model. For example, the model may be physically deleted from the model management unit 106 or the model may be logically deleted from the model management unit 106 so that the model cannot be used. On the other hand, in a case where the recognition apparatus 101 provides a service to a plurality of users or organizations, the model may be logically deleted with respect to only a user or an organization that has agreed to change or delete the model, so that the model cannot be used by the user or the organization. Thereafter, the processing proceeds to step S304 and the recognition unit 105 performs recognition processing by using the display target model presented in step S1004.

On the other hand, if the user does not agree to change the model, the processing proceeds to step S1009, and the model management unit 106 determines to use the non-displayed model indicated by the model information in the recognition processing. Thereafter, the processing proceeds to step S304 and the recognition unit 105 performs recognition processing by using the non-displayed model. Note that if the non-displayed model indicated by the model information is no longer supported, such as a case where a predetermined period has elapsed from when the model was determined to be a non-displayed model, the model management unit 106 may issue a warning in step S1009 and end the processing.

According to this embodiment, it is possible to reproduce a past recognition environment based on model information output in the past recognition processing and, after the model is updated, propose a recognition environment similar to the past recognition environment by presenting a model similar to the model prior to the updating and a recognition result obtained with use of the model. With this configuration, it is possible to urge the user to transition to a new model.

A recognition apparatus according to another embodiment of the preset invention includes: a recognition unit 105 that performs recognition processing on recognition target information that is a target of the recognition processing with use of a model; and an output unit 108 that outputs information indicating details of the recognition processing performed by the recognition unit 105 in association with a result of the recognition processing. By using such information output by the recognition apparatus and indicating details of the recognition processing, it is possible to easily reproduce a recognition environment in future recognition processing. Configurations of the recognition unit 105 and the output unit 108 are similar to those in the embodiment described above, and the recognition apparatus may further include the functional units described above.

As described above, the recognition unit 105 can be realized in various forms such as a library in the recognition apparatus 101, or a server or a cloud service other than the recognition apparatus 101. The snapshots 801 of the recognition units shown in FIG. 8 can be realized in various forms such as container images, server images, dynamic link libraries, versions of a cloud service, or scripts in accordance with the form of the recognition unit 105.

### Embodiment 2

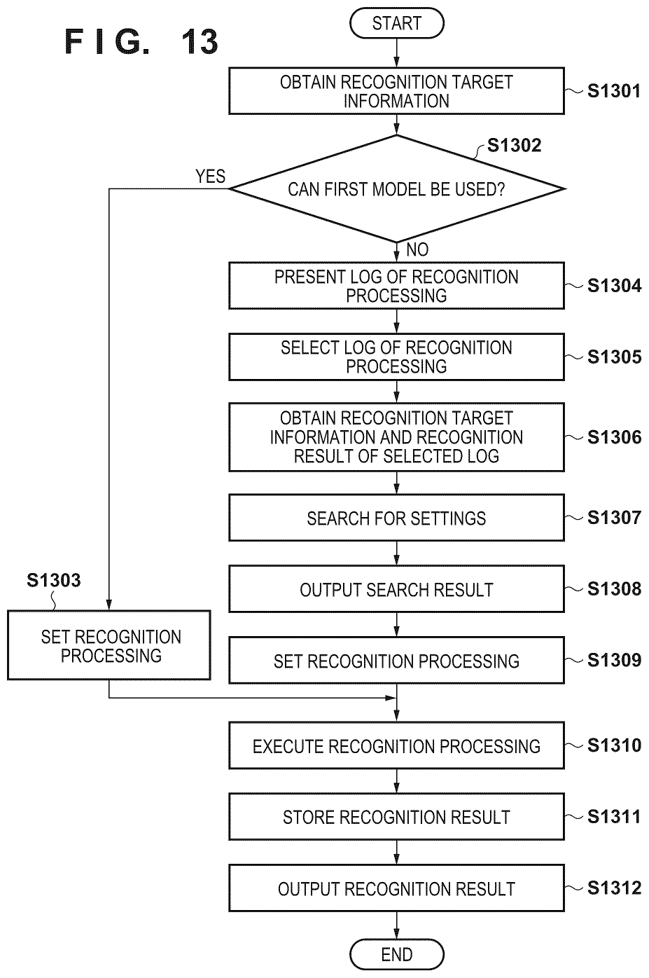

FIG. 12 shows a functional configuration of a recognition apparatus according to Embodiment 2, which is an embodiment of the present invention. Similarly to Embodiment 1, information (recognition target information) 1102 is input to a recognition apparatus 1101, and the recognition apparatus 1101 outputs a recognition result 1103 obtained by performing recognition processing on the recognition target information 1102. The type of the target of recognition processing and the type of the recognition processing are similar to those in Embodiment 1. In the following embodiment as well, a case is described in which the recognition apparatus 1101 recognizes a defect such as a crack occurring in a structure included in an image from the image. The recognition apparatus 1101 according to the present embodiment can also be realized by a computer that includes a processor and a memory, similarly to Embodiment 1. FIG. 2 shows a hardware configuration example of the recognition apparatus 1101 according to an embodiment.

Next, the following describes a functional configuration of the recognition apparatus 1101 according to the present embodiment with reference to the block diagram shown in FIG. 12. When a model that was used in the past in recognition processing is discontinued, the recognition apparatus 1101 according to the present embodiment makes it easy to search for a setting of recognition processing with which it is possible to obtain a similar result.

As shown in FIG. 12, the recognition apparatus 1101 includes a recognition unit 1105, a model management unit 1106, an output unit 1108, and a search unit 1120. The model management unit 1106 manages models to be used in recognition processing.

The search unit 1120 obtains a result of first recognition processing performed on first recognition target information with use of a first model.

The recognition unit 1105 performs recognition processing on recognition target information. The recognition unit 1105 can perform the recognition processing by using a model managed by the model management unit 1106. Also, the recognition unit 1105 can perform the recognition processing in accordance with processing parameters that are set. In the present embodiment, the recognition unit 1105 performs recognition processing on the first recognition target information by using a model managed by the model management unit 1106 other than the first model in accordance with each of a plurality of settings and generates results of the recognition processing respectively corresponding to the plurality of settings. Also, the recognition unit 1105 can perform recognition processing on second recognition target information. At this time, the recognition unit 1105 can perform the recognition processing in accordance with a setting of the recognition processing that is set with reference to a setting output by the output unit 1108.

The output unit 1108 outputs a setting corresponding to a result of recognition processing selected based on a comparison with the result of the first recognition processing from the results of recognition processing respectively corresponding to the plurality of settings. For example, the output unit 1108 can output a model and processing parameters set by the search unit 1120, which correspond to the result of recognition processing selected by a determination unit 1121 or selected in accordance with input made by the user. Also, the output unit 1108 can output a result of recognition processing managed by a log management unit (log manager) 1122.

The recognition apparatus 1101 can further include an information input unit 1104, a setting unit 1107, the search unit 1120, the determination unit 1121, and the log management unit 1122. The information input unit 1104 can obtain the second recognition target information.

The setting unit 1107 can perform setting of the recognition processing. For example, the setting unit 1107 can perform setting of the recognition processing in accordance with input made by the user.

Furthermore, the search unit 1120 can produce the plurality of settings used in the recognition processing performed by the recognition unit 1105 on the first recognition target information. The search unit 1120 can produce the plurality of settings by combining models and processing parameters to be used based on a search algorithm.

The determination unit 1121 can determine a degree of similarity between results of recognition processing. Specifically, the determination unit 1121 can determine a degree of similarity between the result of the first recognition processing and each of the results of recognition processing respectively corresponding to the plurality of settings. Also, the determination unit 1121 can select a result of recognition processing according to the degree of similarity from the results of recognition processing respectively corresponding to the plurality of settings. In the present embodiment, the determination unit 1121 calculates the degree of similarity based on a difference between two recognition results as described later.

The log management unit 1122 manages recognition target information and results of recognition processing performed on the recognition target information. The log management unit 1122 may also manage settings of the recognition processing in association with the results of the recognition processing. The settings of the recognition processing can include information for identifying a model, such as a model ID that is identification information of the model. Also, the settings of the recognition processing can include processing parameters used in the recognition processing performed with use of the model. Furthermore, the settings of the recognition processing can include information indicating a recognition target. As described above, the settings of the recognition processing can indicate details of the recognition processing and can be called “model information”. The log management unit 1122 may also manage recognition target information that is the target of the recognition processing.

In the following example, the first recognition target information and the second recognition target information are information of the same type or information regarding the same type of target, and are a first image and a second image of a structure, for example. The first image and the second image may be obtained by capturing images of the same structure at different times. For example, the time at which the second image was captured may be a few years later than the time at which the first image was captured.

In the following example, it is possible to obtain a setting of recognition processing performed with use of a model managed by the model management unit 1106, the setting enabling reproduction of a recognition result that is similar to the result of the first recognition processing performed in the past on the first image with use of the first model. Such a setting can indicate a model and processing parameters to be used in the recognition processing, and the model and the processing parameters will be hereinafter referred to as a “similar model” and “similar parameters”. Then, recognition processing is performed on the second image in accordance with a setting of the recognition processing set with reference to the thus obtained setting of recognition processing. This makes it possible to perform the recognition processing on the second image in a recognition environment that enables reproduction of a recognition result similar to the result of the first recognition processing performed in the past. Such a similar model and similar parameters can be used in recognition processing performed on images to perform comparison over time.

Next, the following describes recognition processing performed by the recognition apparatus according to the present embodiment with reference to the flowchart shown in FIG. 13. In step S1301, the information input unit 1104 obtains recognition target information. In this example, the information input unit 1104 obtains the second image.

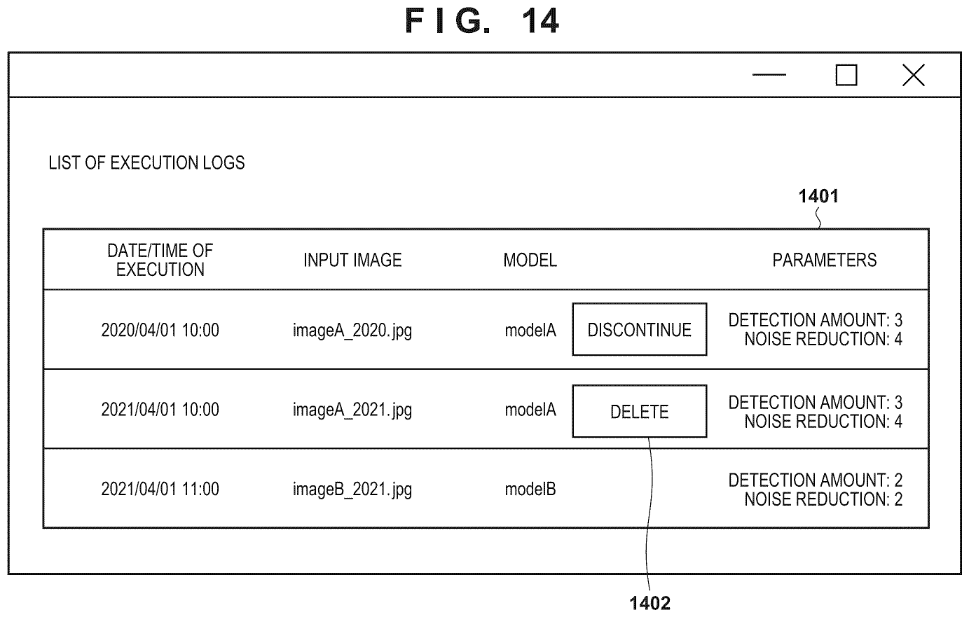

In step S1302, the setting unit 1107 confirms whether or not the first model that was used in the past in recognition processing performed on the first image can be used. In an embodiment, the output unit 1108 can present logs of recognition processing managed by the log management unit 1122 to the user. For example, the output unit 1108 can present a list of execution logs of recognition processing to the user as shown in FIG. 14. The output unit 1108 may also present a setting of each recognition processing to the user. A list 1401 shown in FIG. 14 shows date and time at which recognition processing was executed, an input image that is recognition target information, identification information of a model used in the recognition processing, and processing parameters used in the recognition processing. The processing parameters can include a detection amount parameter for controlling the amount of the recognition target to be detected in the recognition processing (making the recognition target more likely to be detected or less likely to be detected), for example. Also, the processing parameters can include a noise reduction parameter indicating the intensity of noise reduction processing that is preprocessing performed on the recognition target information. Of course, the processing parameters are not limited to these types of parameters.

The list 1401 further includes a notification 1402 indicating that the corresponding model used in the past recognition processing has been discontinued and cannot be used. Thus, the model management unit 1106 can give a notification indicating whether or not a model can be used, on the list of execution logs via the output unit 1108. The model management unit 1106 may also use another method to give the notification indicating whether or not a model can be used, and may give the notification on another screen such as a top screen of a recognition processing system or a model management screen, for example.

The user can identify a log of recognition processing performed to recognize the same recognition target in an image of the same structure as that included in the second image, from the execution logs. The thus identified recognition processing is the first recognition processing. Also, the user can confirm whether or not the model used in the first recognition processing performed on the first image can be used, based on identification information of the model and a state of discontinuation of the model, which are displayed in the list of execution logs.

In the present embodiment, when the user confirms whether or not the model used in the first recognition processing can be used and if it is confirmed that the first model can be used, the setting unit 1107 obtains a user instruction indicating that recognition processing is to be performed with use of the first model, and then the processing proceeds to step S1303. On the other hand, if the first model cannot be used, the setting unit 1107 obtains a user instruction indicating that model search processing is to be performed, and then the processing proceeds to step S1304.

On the other hand, the setting unit 1107 may also obtain a user instruction selecting the first recognition processing from among the presented logs of recognition processing. In this case, the setting unit 1107 can confirm whether or not the first model used in the first recognition processing specified by the user can be used, by referring to the model management unit 1106. If the first model can be used, the processing proceeds to step S1303, and if the first model cannot be used, the processing proceeds to step S1304.

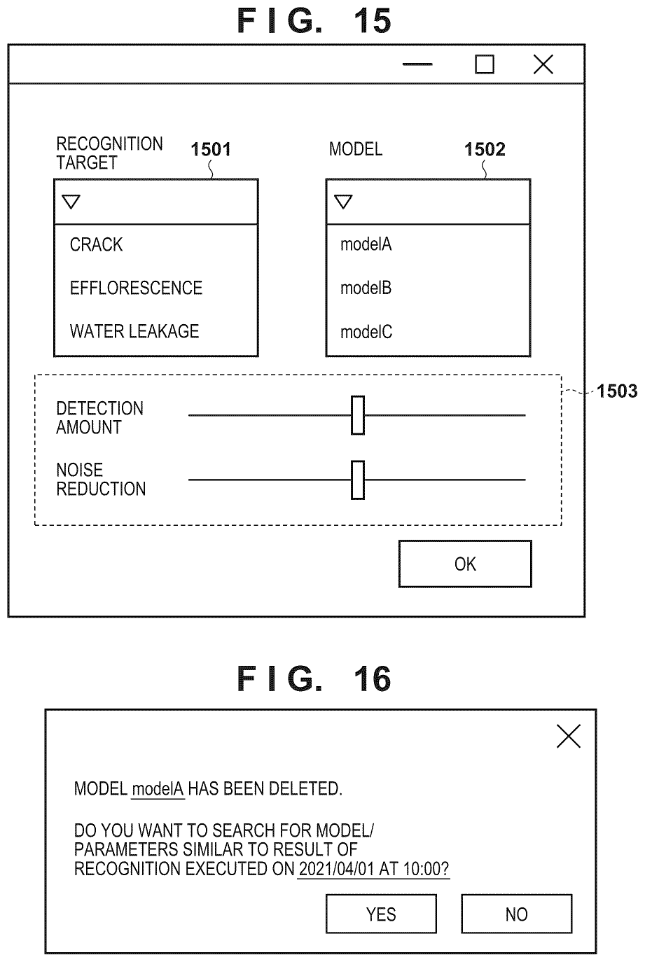

In step S1303, the setting unit 1107 obtains a setting of recognition processing for the second recognition target information, which is set with reference to the setting of the first recognition processing. In an embodiment, the user can perform setting of the recognition processing by referring to the setting of the first recognition processing. FIG. 15 shows an example of a user interface (UI) for setting a model and processing parameters. The UI includes a list 1501 for selecting a recognition target, a list 1502 for selecting a model to be used in the recognition processing, and sliders 1503 for setting processing parameters. There is at least one model for each recognition target.

Of course, the setting unit 1107 may perform setting of the recognition processing for the second recognition target information in such a manner that the same processing as the first recognition processing will be performed.

Alternatively, initial values in a UI like that shown in FIG. 15 may be set in accordance with the setting of the first recognition processing. Furthermore, the setting unit 1107 may automatically perform setting of the recognition processing while giving consideration to an attribute of the recognition target information (e.g., a time zone in which the information was obtained, the brightness of the image, or GPS information) and the type of the recognition target.

In step S1304 and the following steps, a search for a similar model and similar parameters is performed. FIG. 16 shows an example of a UI for proposing the search for a similar model and similar parameters to the user and accepting a user instruction before proceeding to step S1304. Such a UI can be displayed in response to the user selecting a log of recognition processing performed with use of a model that cannot be used in step S1302. Alternatively, such a UI may also be displayed in response to the user selecting a model that cannot be used in step S1303.

In step S1304, the output unit 1108 presents logs of recognition processing managed by the log management unit 1122 to the user. Also, in step S1305, the setting unit 1107 obtains a user instruction selecting the first recognition processing from among the presented logs of recognition processing. The processing in steps S1304 and S1305 can be performed as described above regarding step S1302. Note that if the first recognition processing has already been selected in step S1302, for example, steps S1304 and S1305 can be omitted.

In step S1306, the search unit 1120 obtains the result of the first recognition processing performed on the first recognition target information with use of the first model from the log management unit 1122. That is to say, the search unit 1120 can obtain a recognition result managed by the log management unit 1122 in association with the log selected in step S1305. Furthermore, the search unit 1120 can obtain the first recognition target information from the log management unit 1122. For example, the search unit 1120 can obtain the first image managed by the log management unit 1122 in association with the log selected in step S1305. In another embodiment, the search unit 1120 may obtain the first recognition target information and the result of the first recognition processing, which have been exported.

In step S1307, the search unit 1120 and the determination unit 1121 search for a similar model and similar parameters based on the result of the first recognition processing and the first recognition target information obtained in step S1306. Specifically, a result of recognition processing is selected from results of recognition processing respectively corresponding to a plurality of settings, based on a comparison with the result of the first recognition processing. The determination unit 1121 can select the result of recognition processing based on a degree of similarity with the result of the first recognition processing as described later. Then, a model and processing parameters used to obtain the selected result of recognition processing are determined to be the similar model and similar parameters. Details of the processing will be described later.

In step S1308, the output unit 1108 outputs the search result obtained in step S1307. In this example, the output unit 1108 presents, to the user, the result of recognition processing selected by the determination unit 1121 among the results of recognition processing respectively corresponding to the plurality of settings.

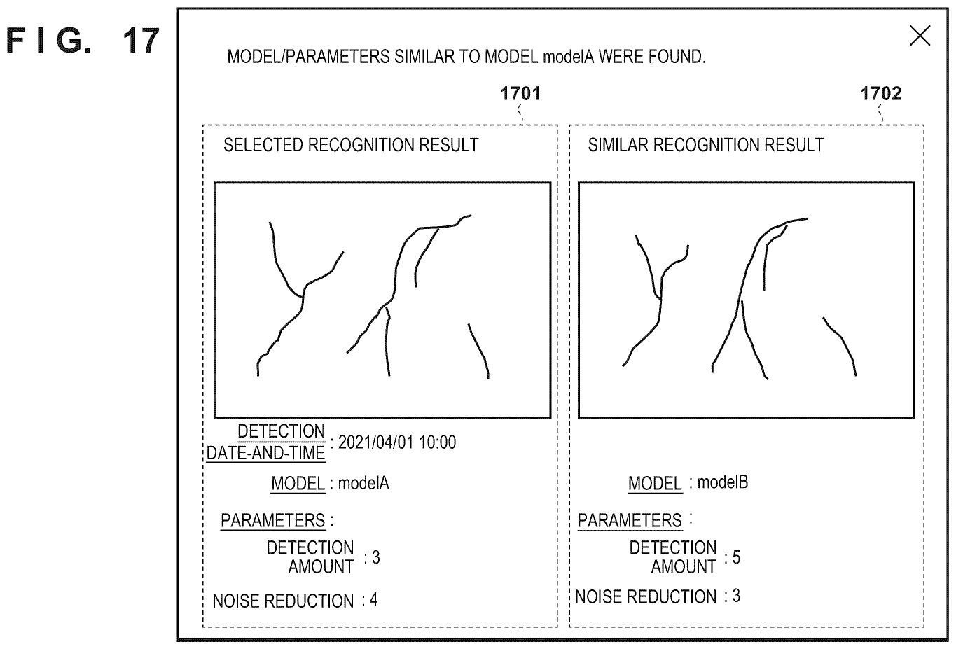

FIG. 17 shows an example of a UI used to present the search result. The result of the first recognition processing obtained in step S1306 is shown in a region 1701, and the result of recognition processing selected by the determination unit 1121 is shown in a region 1702. Also, the output unit 1108 can output a setting corresponding to the result of recognition processing selected in step S1307. Here, the setting output by the output unit 1108 can include information for identifying a model used in the recognition processing. Also, the setting output by the output unit 1108 can include processing parameters used in the recognition processing. For example, the similar model and the similar parameters selected by the determination unit 1121 are also shown in the region 1702. Also, the output unit 1108 may further output a degree of similarly between the result of recognition processing and the result of the first recognition processing determined in step S1307 together with the result of recognition processing.

In step S1309, setting of recognition processing is performed with reference to the setting output by the output unit 1108. For example, the setting unit 1107 accepts input indicating a setting of the recognition processing to be performed on the second recognition target information from the user. Here, the user can perform setting of the recognition processing by referring to the similar model and the similar parameters output in step S1308. Setting of the recognition processing can be performed similarly to the setting performed in step S1303. For example, the user can perform setting of the recognition processing by using the UI shown in FIG. 15. The user may set the similar model and the similar parameters output in step S1308. On the other hand, the user may further adjust the processing parameters. Alternatively, the output unit 1108 may present, to the user, a UI that includes a region in which a setting is presented by the output unit 1108 and a region for accepting, from the user, input indicating a setting of the recognition processing to be performed on the second recognition target information. In this case, the user can perform setting of the recognition processing on such a UI.

In another example, the setting unit 1107 may automatically perform setting of the recognition processing to be performed on the second recognition target information in accordance with the setting output by the output unit 1108 in step S1307. For example, the setting unit 1107 can perform setting of the second recognition processing in such a manner that the similar model and the similar parameters output in step S1308 will be used.

In step S1310, the recognition unit 1105 performs recognition processing on the second recognition target information in accordance with the setting of the recognition processing set in step S1303 or S1309. For example, the recognition unit 1105 performs the recognition processing on the image obtained in step S1301 with use of the set model and processing parameters.

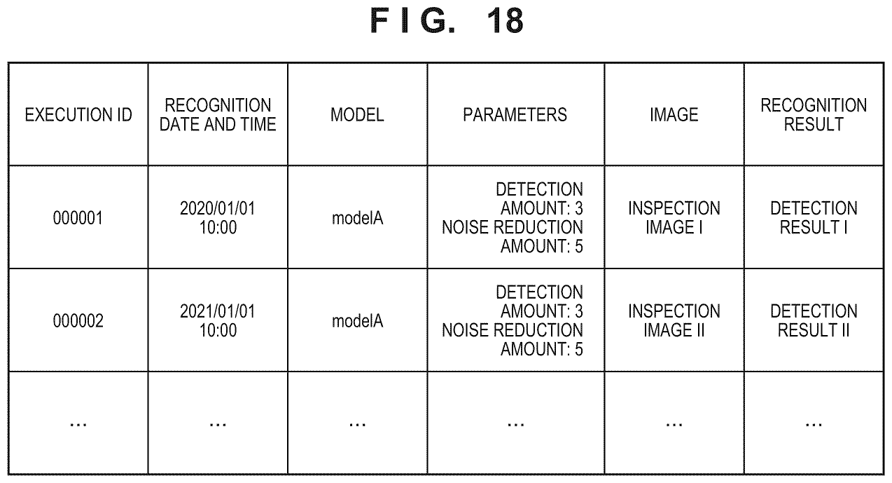

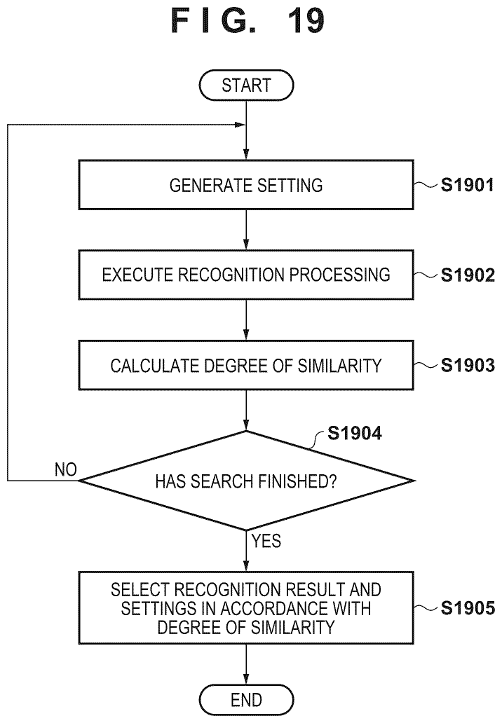

In step S1311, the log management unit 1122 stores a log of the recognition processing performed on the second recognition target information in step S1310. Here, the log management unit 1122 can store the model and the processing parameters used in the recognition processing, the second recognition target information, and the recognition result. FIG. 18 shows an example of log information stored in the log management unit 1122. As shown in FIG. 18, recognition date and time, identification information of an image that is recognition target information, identification information of a model, and processing parameters are stored in association with each execution ID for identifying a log. Note that the log information stored in the log management unit 1122 may also include information indicating the recognition target or identification information of the user who executed the recognition processing, for example.

In step S1312, the output unit 1108 outputs the result of recognition processing obtained in step S1310. In the present embodiment, the output unit 1108 can superimpose the position of a recognized defect such as a crack on the image that is the recognition target information and output the superimposed image. Also, the output unit 1108 may output vector data of the crack. Of course, there is no particular limitation on the recognition processing performed by the recognition apparatus according to the present invention as described above, and the output unit 1108 may output the result in various forms. Such a result of recognition processing can be displayed on a display device such as a display, and the user can check the result.

Next, the following describes search processing performed by the search unit 1120 and the determination unit 1121 in step S1307 with reference to the flowchart shown in FIG. 19. As described above, the execution log of the first recognition processing has been selected in step S1305 and the search unit 1120 has obtained a first recognition result and the first image stored in the log management unit 1122 in step S1306. The search unit 1120 searches for a similar model and similar parameters based on the first recognition result and the first image.

In step S1901, the search unit 1120 generates a setting for recognition processing. In step S1902, the recognition unit 1105 performs recognition processing on the first recognition target information in accordance with the setting generated in step S1901. In step S1903, the determination unit 1121 determines a degree of similarity between a recognition result obtained in step S1902 and the first recognition result. In step S1904, the search unit 1120 determines whether or not to continue the search. When the search is continued, the processing returns to step S1901, and a new setting for recognition processing is generated. When the search is finished, the processing proceeds to step S1905.

By repeating the processing performed in steps S1901 to S1904, the search unit 1120 can generate a plurality of settings for recognition processing. The plurality of settings can respectively include different combinations of models and processing parameters. For example, the search unit 1120 can generate a plurality of settings in which a plurality of models managed by the model management unit 1106 are respectively used. Also, the search unit 1120 can generate a plurality of settings in which different processing parameters are respectively used.

The search unit 1120 can generate settings including models and processing parameters based on a search algorithm. For example, in step S1901, the search unit 1120 may generate settings by using various processing parameters while fixing the model used to a single model. In another method, the search unit 1120 may generate settings by using various models while fixing a processing parameter used to a single processing parameter (e.g., default parameter). There is no particular limitation on the search algorithm used by the search unit 1120, and it is possible to use exhaustive search, grid search, random search, Bayesian optimization, or any other search algorithm, for example.

In an embodiment, the search unit 1120 generates settings in such a manner that a model in association with the first model will be used among the models managed by the model management unit 1106. In this case, the model management unit 1106 can manage correspondence between models. By narrowing the range of search for settings so that only models in association with the first model will be used as described above, it is possible to reduce the time it takes for the search. For example, the model management unit 1106 can manage information specifying one or more models as successor models for the first model. In this case, the search unit 1120 can generate settings in such a manner that the successor models will be used.

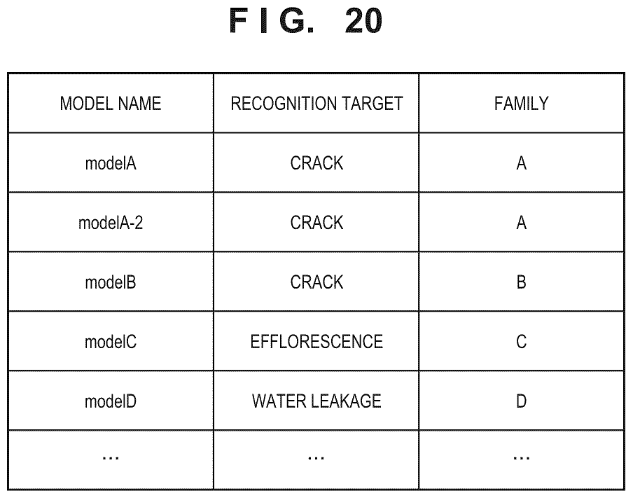

FIG. 20 shows an example of model classification information managed by the model management unit 1106. Identification information of a model, such as a model name, a recognition target of the model, and information indicating a family of the model can be registered in the model management unit 1106. The family is a value given to each model to classify the model by a person who registers the model. The model management unit 1106 may further manage other information regarding the model such as information for identifying users who can use the model, and date and time at which the model was registered, for example. Based on such model classification information, the search unit 1120 can generate settings in such a manner that only models in association with the first model will be used. For example, the search unit 1120 can perform the search for settings so that models that have the same recognition target and/or the same family as the first model will be used.

In step S1905, the search unit 1120 determines a recognition result for which the degree of similarity calculated in step S1903 is the highest among recognition results respectively obtained in accordance with the plurality of settings generated by repeating the processing performed in step S1902. A model and parameters used to obtain the recognition result are taken to be the similar model and the similar parameters. The similar model and the similar parameters determined in step S1905 are output by the output unit 1108 in step S1308.

The following describes a method for determining the degree of similarity in step S1903. In step S1903, the determination unit 1121 can estimate a difference between the first recognition result and the recognition result obtained in step S1902 and obtain the estimated value as the degree of similarity. In the case where defects are detected from images as in the present embodiment, it is conceivable that images indicating positions of defects are output as recognition results. In such a case, it is possible to determine a difference between two images indicating respective recognition results and calculate a degree of similarity based on the difference.

Specifically, the degree of similarity can be calculated as follows, for example. Each image includes a predetermined number of pixels. Accordingly, a difference between images can be estimated by obtaining absolute values of density differences between corresponding pixels in the two images compared with each other and calculating a sum of the absolute values. In this case, it can be thought that the smaller the difference is, the higher the degree of similarity is, and the larger the difference is, the lower the degree of similarity is. For example, it is assumed that the density of each pixel is represented by 0 to 1, densities of pixels of a recognition result A are A (a_{0,0}, a_{0,1}, . . . , a_{0,n}, a_{1,0}, . . . , a_{n,n}), and densities of pixels of a recognition result B are B (b_{0,0}, b_{0,1}, . . . , b_{0,n}, b_{1,0}, . . . , b_{n,n}). In this case, a degree of similarity between the recognition result A and the recognition result B can be calculated using the following formula (1).

$$S = 1 - \frac{{\sum }_{i , j = 0}^{n} \vert {a}_{i , j} - {b}_{i , j} \vert}{ij} \qquad ( 1 )$$

On the other hand, a defect such as a crack is a localized feature in image data, and accordingly, even if cracks are represented by the same vector data, a slight positional shift may be determined to be a difference. Therefore, it is also possible to adopt a method for calculating the difference by taking a positional shift into account, e.g., by expanding cracks. Note that it is also possible to calculate the degree of similarity by converting vector data indicating results of recognition processing to feature data that is suitable for comparison, and calculating a distance between the feature data.

In the embodiment described above, a recognition result for which the degree of similarity is the highest is determined in step S1905 and a model and parameters used to obtain the recognition result are output as the similar model and the similar parameters in step S1308. On the other hand, a setting that gives a recognition result similar to the result of the first recognition processing and is the most desirable for the user may not be the setting that gives the highest degree of similarity. This is likely to be the case when a recognition result is expressed as visual information or values of a plurality of items and when there is a plurality of settings that give high degrees of similarity, for example. Therefore, the search unit 1120 may select two or more recognition results in step S1905. For example, the search unit 1120 can select a predetermined number of recognition results that have higher degrees of similarity than the other settings.

In this case, in step S1308, the search unit 1120 may output two or more recognition results selected in step S1905 instead of outputting a recognition result for which the degree of similarity is the highest. At this time, the search unit 1120 can output a combination of a model and parameters used to obtain each of the two or more recognition results. According to this configuration, the user can select a recognition result that is in line with the intention of the user from the plurality of recognition results having higher degrees of similarity, and it is possible to set a similar model and similar parameters with which the recognition result in line with the intention of the user can be obtained in step S1309. In another method, in step S1309, the user may make input indicating a recognition result that is in line with the intention of the user among recognition results output in step S1308. In this case, the setting unit 1107 can set a combination of the model and parameters used to obtain the recognition result indicated by the input, as the setting of the recognition processing to be performed on the second recognition target information.

In the embodiment described above, in step S1902, recognition processing is performed on recognition target information that was used in past recognition processing and managed by the log management unit 1122. Also, in step S1903, the result of the past recognition processing managed by the log management unit 1122 is compared with the recognition result obtained in step S1902. On the other hand, recognition processing may also be performed on other recognition target information in step S1902. For example, the first recognition target information used in step S1902 may be a sample image. The sample image is prepared in advance as a general image that is input in recognition processing. In this case, in step S1902, the recognition unit 1105 can perform recognition processing on the sample image in accordance with the setting generated in step S1901.

In this embodiment, the log management unit 1122 can manage results of recognition processing respectively obtained by using a plurality of models on a common recognition target information such as the sample image. For example, the log management unit 1122 can manage a result of first recognition processing performed on the sample image with use of the first model. Then, in step S1903, the determination unit 1121 can compare the result of the first recognition processing performed on the sample image with use of the first model, which is managed by the log management unit 1122, with the recognition result obtained in step S1902.

On the other hand, according to this configuration in which a sample image is used, it is also possible to search for a similar model and similar parameters corresponding to the first model in advance without waiting for an instruction given from the user to search for the similar model and the similar parameters. Accordingly, if such a search is performed when a model is discontinued, for example, it is possible to rapidly present a similar model and similar parameters that generally correspond to the discontinued model.

This configuration can be realized by performing the processing shown in FIG. 19 when the first model is discontinued or it is determined to discontinue the first model. Note that the model management unit 1106 can manage whether or not a model can be used, and discontinuing a model means that the model management unit 1106 sets the model as a model that cannot be used.

In this case, before the processing in step S1901 is performed, the recognition unit 1105 initially performs first recognition processing on the sample image with use of the first model. At this time, processing parameters in accordance with a default setting may be used or the processing parameters may be set by the user. Thereafter, the processing in steps S1901 to S1905 is performed with use of the sample image as the first recognition target information. Thus, a recognition result that has a high degree of similarity with the result of the first recognition processing performed with use of the first model is selected in step S1905. Thereafter, the output unit 1108 can output the setting used to obtain the recognition result selected in step S1905, and the model management unit 1106 can manage the setting in association with identification information of the first model. For example, the model management unit 1106 can store the similar model and the similar parameters used to obtain the recognition result selected in step S1905 in association with the first model, which is discontinued.

As described above, in response to the first model being made unusable, the model management unit 1106 can store the setting output by the output unit 1108 in association with identification information of the first model.

In the case where the model management unit 1106 manages the similar model and the similar parameters associated with the first model as described above, the recognition processing shown in FIG. 13 can be performed as follows. The output unit 1108 can output the similar model and the similar parameters associated with the first model used in the first recognition processing selected in step S1305 by referring to the model management unit 1106, instead of performing the processing in steps S1306 to S1308.

Note that in the case where the model management unit 1106 manages model classification information such as a recognition target or a family of each model as shown in FIG. 20, a sample image may also be prepared for each type of model determined according to the recognition target or the family, for example. In this case, the recognition unit 1105 can obtain a sample image corresponding to the type of the first model by referring to the model management unit 1106 in step S1902.

Note that the recognition apparatus described above may also be realized by a plurality of apparatuses. For example, the recognition apparatus according to an embodiment may be realized by a plurality of information processing apparatuses connected via a network. Particularly when the recognition apparatus 101 or 1101 is a server that receives a request from a user terminal, functions of the recognition unit 105 or 1105 may also be executed by another server. According to this configuration, even if it takes time to perform the processing in the recognition unit 105 or 1105, the processing can be performed by the recognition unit 105 or 1105 asynchronously with the reception of a request. Furthermore, functions of the information processing apparatuses like those shown in FIG. 1 or 12 can be realized by a computer, but some or all of the functions of the information processing apparatuses may also be realized by dedicated hardware.

Also, the recognition unit 1105 can be realized in various forms such as a library in the recognition apparatus 1101, or a server or a cloud service other than the recognition apparatus 1101.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A recognition apparatus comprising one or more memories storing instructions and one or more processors that execute the instructions to:
obtain recognition target information that is a target of recognition processing;
obtain information indicating details of past recognition processing output in the past recognition processing performed with use of a model; and
perform recognition processing on the recognition target information with use of a model in accordance with the information indicating details of the past recognition processing.

2. The recognition apparatus according to claim 1,
wherein the information indicating details of the past recognition processing is associated with a result of the past recognition processing.

3. The recognition apparatus according to claim 1,
wherein the one or more processors execute the instructions to output information indicating details of the recognition processing in association with a result of the recognition processing.

4. The recognition apparatus according to claim 1,
wherein the information indicating details of the past recognition processing includes model information which identifies the model used in the past recognition processing, and
the one or more processors execute the instructions to manage models to be used in the recognition processing and select a model to be used in the recognition processing from the managed models in accordance with the model information, and
perform the recognition processing on the recognition target information with use of the selected model.

5. The recognition apparatus according to claim 4,
wherein the one or more processors execute the instructions to identify a model from the managed models based on the model information and to select the identified model.

6. The recognition apparatus according to claim 4,
wherein the one or more processors execute the instructions to:
select a model to be used in the recognition processing from a first model group in accordance with input made by a user; and
identify a model from a second model group based on the model information from a second model group and select the identified model, and
the number of models included in the first model group is smaller than the number of models included in the second model group.

7. The recognition apparatus according to claim 6,
wherein the one or more processors execute the instructions to present a model selected from the first model group to the user when the model identified based on the model information is not included in the first model group.

8. The recognition apparatus according to claim 7,
wherein the one or more processors execute the instructions to present, to the user, a result of the recognition processing performed with use of the model identified based on the model information and a result of the recognition processing performed with use of the model presented to the user.

9. The recognition apparatus according to claim 8,
wherein the one or more processors execute the instructions to delete the model identified based on the model information in accordance with an instruction form the user to whom the model selected from the first model group is presented.

10. The recognition apparatus according to claim 7,
wherein the one or more processors execute the instructions to manage information indicating correspondence between the model identified based on the model information and the model selected from the first model group and presented to the user.

11. The recognition apparatus according to claim 4, comprising
a plurality of recognizers each corresponding to at least one model included in the managed models,
wherein the one or more processors execute the instructions to switch a recognizer that performs the recognition processing in accordance with the model information.

12. The recognition apparatus according to claim 11,
wherein each of the plurality of recognizers operates on a corresponding container.

13. The recognition apparatus according to claim 12,
wherein the one or more processors execute the instructions to manage snapshots of containers respectively corresponding to the plurality of recognizers and boot the recognizer with use of a snapshot of a container corresponding to the selected model.

14. The recognition apparatus according to claim 4,
wherein the one or more processors execute the instructions to, in response to obtaining the model information indicating substance of a different model from the managed models, perform recognition processing on the recognition target information with use of the different model in accordance with the model information.

15. The recognition apparatus according to claim 1,
wherein the information indicating details of the past recognition processing further indicates a processing parameter used in the past recognition processing, and
the one or more processors execute the instructions to use the processing parameter used in the past recognition processing in the recognition processing on the recognition target information.

16. The recognition apparatus according to claim 1,
wherein the target of the recognition processing is an image, and the recognition processing is processing for recognizing a recognition target in the image.

17. The recognition apparatus according to claim 16,
wherein the recognition target is a defect in a structure included in the image.

18. A recognition apparatus comprising one or more memories storing instructions and one or more processors that execute the instructions to:
perform recognition processing on recognition target information that is a target of recognition processing with use of a model; and
output information indicating details of the recognition processing in association with a result of the recognition processing.

19. A recognition method comprising:
obtaining recognition target information that is a target of recognition processing;
obtaining information indicating details of past recognition processing output in the past recognition processing performed with use of a model; and
performing recognition processing on the recognition target information with use of a model in accordance with the information indicating details of the past recognition processing.

20. A recognition apparatus comprising a model manager configured to manage models to be used in recognition processing, one or more memories storing instructions, and one or more processors that execute the instructions to:
obtain a result of first recognition processing performed on first recognition target information with use of a first model;
perform recognition processing on the first recognition target information in accordance with each of a plurality of settings with use of a model which is different from the first model and is managed by the model manager, and generate results of the recognition processing respectively corresponding to the plurality of settings; and
output a setting corresponding to a result of the recognition processing selected with reference to the result of the first recognition processing from the results of the recognition processing respectively corresponding to the plurality of settings.

21. The recognition apparatus according to claim 20,
wherein the one or more processors execute the instructions to determine a degree of similarity between the result of the first recognition processing and each of the results of the recognition processing respectively corresponding to the plurality of settings, and select the result of the recognition processing from the results of the recognition processing respectively corresponding to the plurality of settings according to the degree of similarity.

22. The recognition apparatus according to claim 21,
wherein the one or more processors execute the instructions to output the degree of similarity together with the result of the recognition processing.

23. The recognition apparatus according to claim 20,
wherein the one or more processors execute the instructions to perform recognition processing with use of a model in association with the first model among the models managed by the model manager.

24. The recognition apparatus according to claim 20,
wherein the recognition processing performed in accordance with each of the plurality of settings is performed with use of each of a plurality of models.

25. The recognition apparatus according to claim 20,
wherein the recognition processing performed in accordance with each of the plurality of settings is performed with use of each of different processing parameters.

26. The recognition apparatus according to claim 20,
wherein the output setting includes information that identifies a model used in the recognition processing.

27. The recognition apparatus according to claim 20,
wherein the output setting includes a processing parameter used in the recognition processing.

28. The recognition apparatus according to claim 20, further comprising a log manager configured to manage recognition target information and results of recognition processing performed on the recognition target information,
wherein the one or more processors execute the instructions to:
obtain a result of the first recognition processing managed by the log manager; and
perform recognition processing on the first recognition target information managed by the log manager.

29. The recognition apparatus according to claim 28,
wherein the result of the first recognition processing is specified by a user from the results of recognition processing managed by the log manager.

30. The recognition apparatus according to claim 20,
wherein the one or more processors execute the instructions to perform recognition processing on second recognition target information in accordance with a setting that is set with reference to the output setting.

31. The recognition apparatus according to claim 20,
wherein the model manager is further configured to manage results of recognition processing performed on common recognition target information with use of a plurality of models.

32. The recognition apparatus according to claim 20,
wherein the model manager is further configured to manage the output setting in association with information that identifies the first model.

33. The recognition apparatus according to claim 32,
wherein the model manager is further configured to, in response to making the first model unusable, store the output setting in association with the information that identifies the first model.

34. A recognition method comprising:
obtaining a result of first recognition processing performed on first recognition target information with use of a first model;
performing recognition processing on the first recognition target information in accordance with each of a plurality of settings with use of a model which is different from the first model and is managed by a model manager configured to manage models to be used in recognition processing, and generating results of the recognition processing respectively corresponding to the plurality of settings; and
outputting a setting corresponding to a result of the recognition processing selected with reference to the result of the first recognition processing from the results of the recognition processing respectively corresponding to the plurality of settings.

35. A non-transitory computer-readable medium storing a program executable by a computer to perform a method comprising:
obtaining recognition target information that is a target of recognition processing;
obtaining information indicating details of past recognition processing output in the past recognition processing performed with use of a model; and
performing recognition processing on the recognition target information with use of a model in accordance with the information indicating details of the past recognition processing.

36. A non-transitory computer-readable medium storing a program executable by a computer to perform a method comprising:
obtaining a result of first recognition processing performed on first recognition target information with use of a first model;
performing recognition processing on the first recognition target information in accordance with each of a plurality of settings with use of a model which is different from the first model and is managed by a model manager configured to manage models to be used in recognition processing, and generating results of the recognition processing respectively corresponding to the plurality of settings; and
outputting a setting corresponding to a result of the recognition processing selected with reference to the result of the first recognition processing from the results of the recognition processing respectively corresponding to the plurality of settings.
